(19) United States
(12) Patent Application Publication
(10) Pub. No.: US 2013/0269960 A1
(43) Pub. Date: Oct. 17, 2013

(54) MOUNTING ASSEMBLY FOR AGRICULTURAL EQUIPMENT

(71) Applicant: PENTA TMR INC., Petrolia (CA)

(72) Inventor: John BAKER, Wyoming (CA)

(73) Assignee: PENTA TMR INC., Petrolia, ON (CA)

(21) Appl. No.: 13/768,199

(22) Filed: Feb. 15, 2013

Related U.S. Application Data
(60) Provisional application No. 61/623,326, filed on Apr. 12, 2012.

(51) Int. Cl. A01B 61/04

(52) U.S. Cl. CPC A01B 61/046
USPC 172/705

(57) ABSTRACT

A mounting assembly for mounting a tool to a frame and a system for working land are provided. The mounting assembly includes a base for attaching to the frame, a bushing fastener connected to the tool, and an elastomeric bushing between the base and the bushing fastener for allowing dampened movement of the tool with respect to the frame.

### CROSS REFERENCE TO RELATED APPLICATIONS

This application claims the benefit of priority of U.S. Provisional Patent Application No. 61/623326 filed Apr. 12, 2012, which is incorporated herein by reference in its entirety.

### FIELD

The present disclosure relates generally to a mounting assembly. More particularly, the present disclosure relates to a mounting assembly for agricultural equipment including an elastomeric bushing.

### BACKGROUND

Large farming and agricultural equipment is desirable when working large fields. Such agricultural equipment may include cultivators, tillage or aerator equipment. Using a cultivator as an example, a modern farm's standard implement for cultivating soil is through the use of a cultivator implement. A conventional cultivator implement is generally supported by a wheeled frame and pulled by a drive system or power source, typically a tractor. The cultivator support frame generally has a number of cross members which are transverse to the direction of travel of the power source. The frame cross-members provide attachment points for the various tools such that the tools can then extend downwardly towards the soil.

Some conventional mounting assemblies used in farm equipment provide for rigidly attaching farm tools to the support frame. When a tool that is rigidly mounted encounters an obstruction on or beneath the land, the tool will typically deflect. If this obstruction is large or hard enough, this deflection can cause damage to the tool, the frame, the tractor, other equipment, or to the obstruction itself.

Other conventional mounting assemblies make use of tensions springs to allow the farm tools to deflect or move in relation to the frame. However, these mounting assemblies can add to the weight of the equipment causing compaction in the field. There can also be issues with replacing the tension springs and providing appropriate loading.

It is, therefore, desirable to provide an improved flexible mounting assembly that overcomes at least some of the problems of conventional mounting assemblies.

### SUMMARY

In an aspect, the present disclosure provides a mounting assembly for use in agricultural equipment. In some cases, the mounting assembly includes a bushing provided at the head of the tool.

In a first aspect, the present disclosure provides a mounting assembly for mounting a tool to a frame. The mounting assembly includes a base for attaching to the frame, a bushing fastener connected to the tool, and an elastomeric bushing between the base and the bushing fastener for allowing dampened movement of the tool with respect to the frame.

In a further aspect, the present disclosure provides agricultural equipment. The agricultural equipment includes a tool for working the land, a frame for attaching to a drive system, a base attached to the frame, a bushing fastener connected to the tool, and an elastomeric bushing between the base and the bushing fastener for allowing dampened movement of the tool with respect to the frame.

In a further aspect, a frame attachment attaches the base to the frame and a pivot bolt is provided in the frame attachment. The tool pivots about the pivot bolt to cause the bushing bolt to compress the elastomeric bushing. The elastomeric bushing is able provide dampening of rotational movement of the tool.

In a further aspect, a tool attachment attaches to the tool and has a groove. A shaft is provided in the groove and connects to the bushing fastener.

In an embodiment, the elastomeric bushing is made of natural rubber or a synthetic elastomer. Tightening or loosening of the bushing fastener can adjust the dampened movement of the tool. The elastomeric bushing can be removable and replaceable by unfastening the bushing fastener. The elastomeric bushing can be selected to provide a desirable amount of dampened movement of the tool.

In an aspect, the tool is selected from any one of a cultivator implement, a shank, a C-shank, a S-tine, a tiller, an aerator, a shovel, a chisel plough, a hoe, a mattock, an opener, a knife, and a cultivator.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a steel spring mounting assembly for a farm tool;

FIG. 2 is a plurality of mounting assemblies attached to a frame, in accordance with an embodiment;

FIGS. 3A and 3B are a detailed perspective view and a perspective view, respectively, of a mounting assembly for farm equipment, in accordance with an embodiment;

FIGS. 4A and 4B are side and front views, respectively, of the mounting assembly of FIGS. 3A and 3B;

FIG. 5 is a further perspective view of the mounting assembly of FIG. 3A and 3B;

FIG. 6 is a tool attachment plate of the mounting assembly of FIG. 3A and 3B; and

FIG. 7 is a frame attachment plate of the mounting assembly of FIG. 3A and 3B.

### DETAILED DESCRIPTION

Generally, the present disclosure provides a mounting assembly and system for mounting a tool to a frame, for use in farm equipment, such as a cultivator, tillage, or aerator implement.

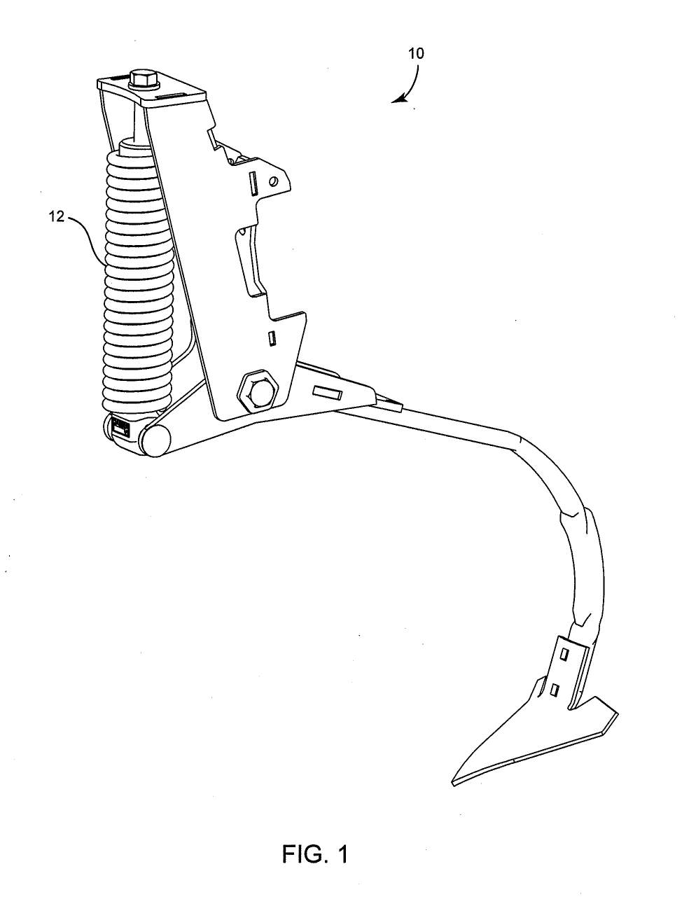

A mounting assembly 10, for example as shown in FIG. 1, may include steel tension springs 12 if a flexible mounting is desired. This arrangement may allow for some movement with respect to the support frame. However, this arrangement can also dramatically increase the weight of the farm equipment because heavy springs are needed to provide adequate stability to the farm tool, which may lead to increased compaction in the field. Additionally, as a result of having to load the spring, this arrangement may make it difficult and cumbersome to interchange and replace springs in the assembly.

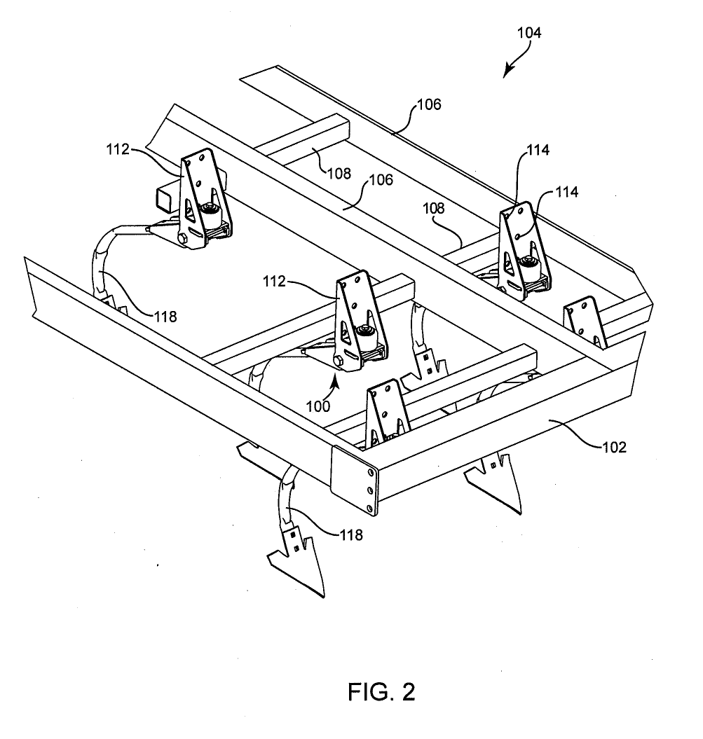

FIG. 2 illustrates an embodiment of a cultivator 104, having a plurality of mounting assemblies 100. The plurality of mounting assemblies 100 are used to mount a farm tool 118 such as, for example, shanks, C shanks, S tines, tillers, shovels, chisel ploughs, hoes, mattocks, openers, knives, or sweep cultivators, to a frame 102 of a piece of farm equipment (not shown), such as a cultivator, tillage, or aerator implement. The frame 102 includes longitudinal support bars 106 connected to latitudinal support bars 108.

The mounting assembly 100 is mounted to the latitudinal support bars 108 of the frame 102, via a frame attachment plate 112. The frame attachment plate 112 includes a plurality of apertures 114 by which the frame attachment plate 112 is attached to the latitudinal support bars 108 by at least one fastener (not shown), for example, nut and bolt, screw, or the like. The plurality of apertures 114 may be located at varying heights along the frame attachment plate to allow for the raising or lowering of the mounting assembly 100 with respect to the frame 102. The frame 102 is intended to support a plurality of mounting assemblies and tools 118, spaced on the frame 102 for cultivating, plowing, or otherwise working the land.

In an alternative embodiment, the frame attachment plate 112 is welded onto the frame 102.

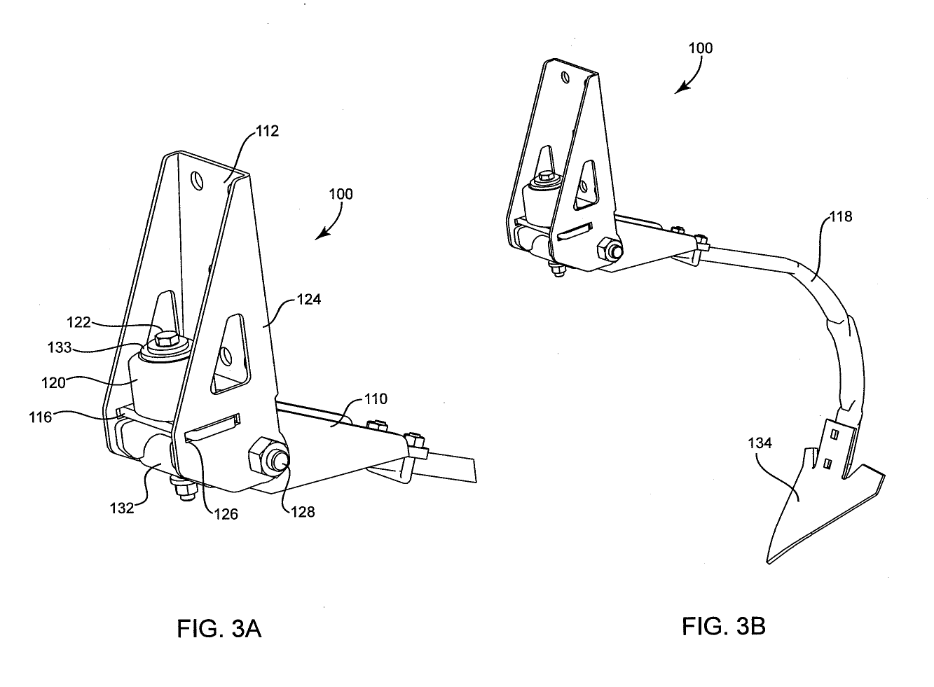

FIGS. 3A and 3B illustrate an embodiment of the mounting assembly 100 in further detail. The frame attachment plate 112 is connected to a base 116. The base 116 may be affixed to or integrally formed with the frame attachment plate 112. The base 116 abuts a tool attachment plate 110. The tool attachment plate 110 connects to the tool 118.

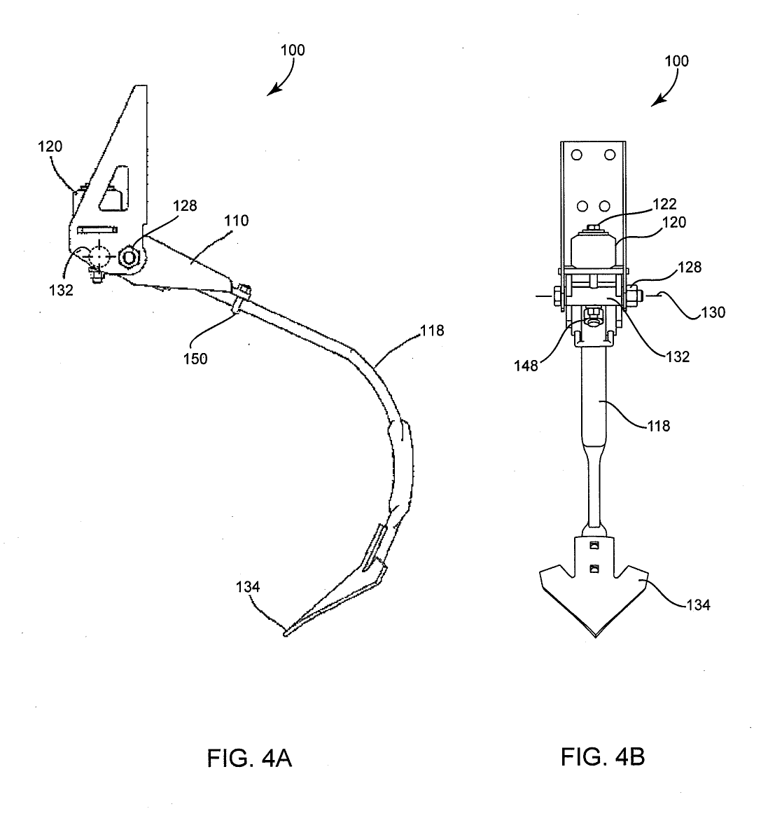

The mounting assembly 100 includes a bushing 120. The bushing 120 is made of a compressible elastomeric material. The compressible elastomeric material can be naturally occurring, such as rubber, or synthetic, such as styrene-butadiene rubbers. The elastomeric material is selected such that the bushing 120 deformable and provides dampening. The bushing 120 is mounted on a front side of the frame attachment plate 112 and on a top side of the base 116 of the mounting assembly 100. The bushing 120 provides dampened movement of the tool 118 with respect to the frame 102. The busing 120 is intended to work similar to a shock absorber such that it allows cushioned movement of the tool 118 on a pivot axis 130 (shown in FIG. 4B). A bushing bolt 122 is attached through a passage in the bushing 120, through an aperture in the base 116, and to a shaft 132. Washers 133 may be used in conjunction with the bushing bolt 122.

The bushing bolt 122 may be tightened for more tip pressure on an end 134 of the tool 118 (i.e. the shank tip). The bushing 120 may also be changed to a larger or smaller, in height or diameter, rubber bushing 120 to add more or less tip pressure as desired. As the bushing 120 is located on the front side of the shank mount assembly 100, it is intended to be easier to access and tighten or change the bushing 120 when desired.

The frame attachment plate 112 further includes side plates 124. The side plates 124 may be integrated with the frame attachment plate 112 to form a single piece of material or may be attached to the frame attachment plate through welding, screws, or the like. The side plates 124 may include a base receiving aperture 126. Tool attachment 110 is rotatably attached to the side plates 124 through a fastener such as a pivot bolt 128, a screw or the like. The pivot bolt 128 is concentric about pivot axis 130 (shown in FIG. 4B).

The side plates 124 and fasteners are intended to limit the sideways movement of the tool 118 while the bushing 120 and the pivot bolt 128 allow for pivot movement of the tool 118 about pivot axis 130.

In some cases, the mounting assembly 100 may weigh approximately 35% less than a conventional steel spring mounting assembly (e.g. shown in FIG. 1), as materials used for the bushing are lighter than those used in conventional steel spring systems. As the mounting assembly 100 is designed to be lighter than a conventional mounting assembly (having a steel spring shank), there is intended to be less compaction of the field when used in tillage.

If the bushing bolt 120 shows signs of wear or if a larger or smaller bushing 120 is preferred in the current use of the farm equipment, the bushing bolt 120 may be replaced. The bushing 120 may be easily replaced by unfastening the bushing bolt 122. The bushing 120 may also be replaced with a harder or softer type of rubber bushing 120 in order to allow less or more, respectively, movement of the tool 118.

FIG. 4A and FIG. 4B illustrate a side view and a front view, respectively, of the embodiment of the mounting assembly 100 in further detail. The compressible bushing 120 is designed to allow the mounting assembly 100 to rotate on a pivot axis 130 created by the pivot bolt 128. The rubber bushing 120 is designed to place a downward force on the tool 118 but continue to allow the tool 118 to have some movement in order to reduce wear on the tool 118 when the tool 118 comes into contact with an obstacle such as a rock or other hard surface while working the land. The bushing 120 is intended to cushion the tool 118 and allow some flexible movement of the tool 118 when the bushing 120 compresses. A small compression in the bushing 120 will allow for a greater or more substantial movement in the tool 118, which is intended to allow the tool 118 to avoid obstacles in the field. For example, where the end of the tool 134 comes into contact with an obstacle in the field, the tool 118 will rotate back about pivot axis 130 and the tool attachment plate 110 will rotate counterclockwise (as shown in FIG. 4A) about pivot axis 130. The tool attachment plate 110 will push down on shaft 132, which in turn will lower the bushing bolt 122 and compress the bushing 120.

In this embodiment, the bushing bolt 122 passes through the center of the shaft 132. This configuration is intended to prevent the bushing bolt 122 from wearing or bending during rotation of the tool 118.

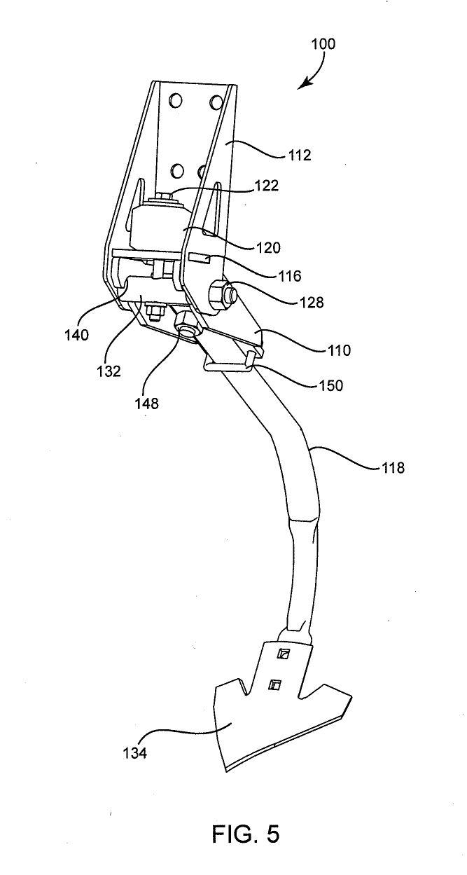

FIG. 5 illustrates a further perspective view of the embodiment of the mounting assembly 100 in further detail.

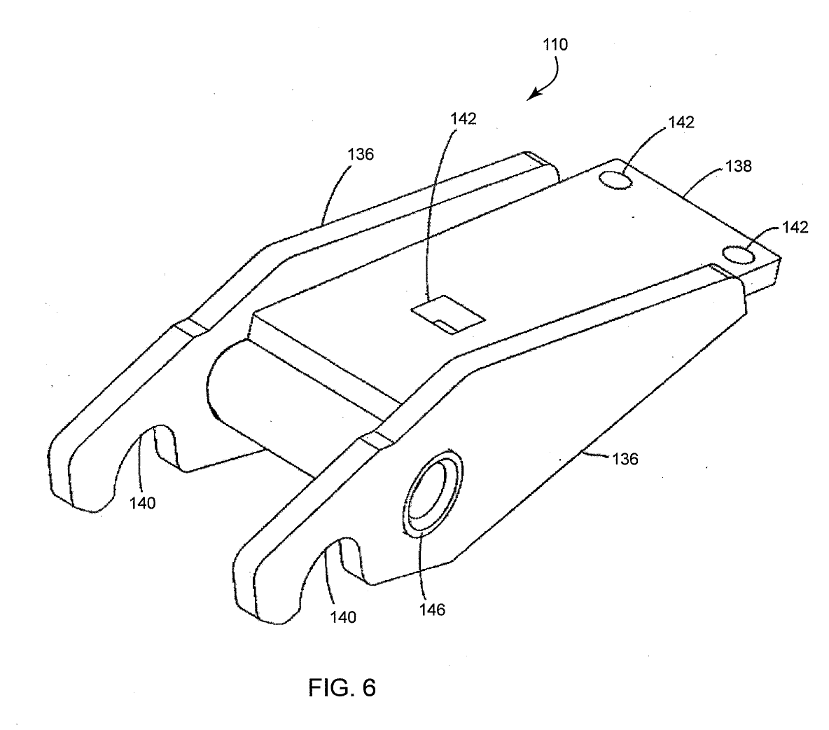

FIG. 6 illustrates the tool attachment plate 110. The tool attachment plate 110 has two side mounting walls 136 and a back mounting wall 138. The side mounting walls 136 each have an aperture 146 for receiving the pivot bolt 128. The apertures 146 may be lined with a material that promotes pivoting of the pivot bolt 128. For example, the apertures 146 may be lined with brass.

The side mounting walls 136 each have a groove 140 for receiving the shaft 132 (shown in FIGS. 3-5). The shaft 132 may rotate within the groove 140 when the tool attachment plate 110 rotates. The rotation of the shaft 132 is intended to prevent the bushing bolt 122 from bending during rotation of the tool attachment plate 110.

The back mounting wall 138 has apertures 142 for securing to the tool 118. For example, the tool 118 may be secured to the tool attachment plate 110 using a tool attachment nut and bolt 148 and a U shaped bolt 150 (shown in FIGS. 4A, 4B, and 5A) that passes through apertures 142.

In an alternative embodiment, the tool attachment plate 110 is welded to the tool 118.

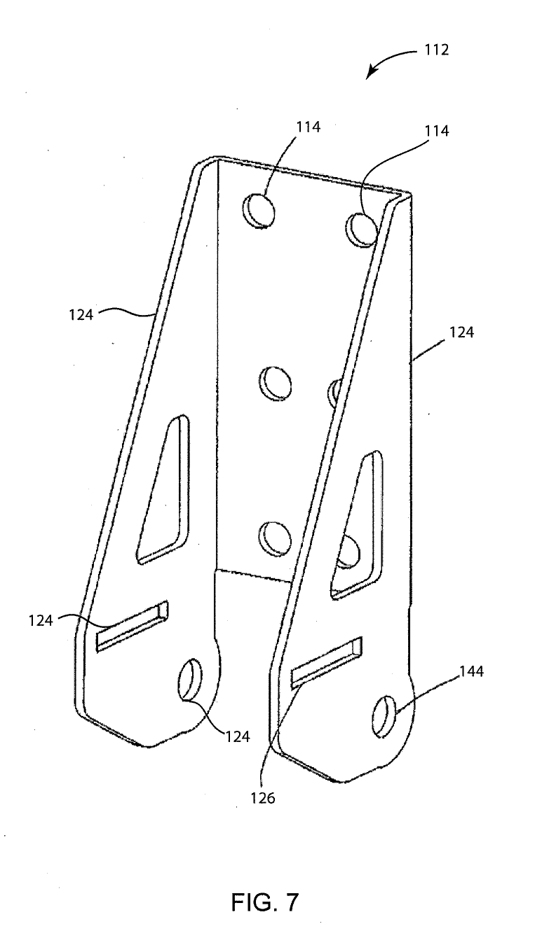

FIG. 7 illustrates the frame attachment plate 112. The frame attachment plate 112 has a pair of the side plates 124, apertures 114, and a pair of base receiving apertures 126. The side plates 124 also each have an aperture 144 for receiving the pivot bolt 128. The pivot bolt 128 rotatably attaches the frame attachment plate 112 to the tool attachment plate 110 as the pivot bolt 128 is received by the apertures 144 in the frame attachment plate 112 and the apertures 146 in the tool attachment plate 110.

In a further embodiment, the frame attachment plate 112 may be configured such that the apertures 114 are located on the side plates 124 such that the mounting assembly 100 can be attached to one of the longitudinal support bars 106.

In another embodiment, the mounting assembly can be customized and scaled for use with residential or commercial garden cultivators or tillers. In other cases, the mounting assembly can be customized for tools associated with, for example, snow clearing, ground cleaning, soil or sand sifting, or raking.

In a further embodiment, the bushing 120 may be located on an opposite surface (the underside) of the base 116 as compared to embodiments illustrated in the Figures. In this arrangement, the shaft 132 and pivot bolt 128 may also be located on the underside relative to the base 116 or located above the base 116.

In a further embodiment, the mounting assembly 100 may be configured in such a way that the elastomeric bushing 120 is stretched, rather than compressed, when the tool 134 is forced upwards due to coming into contact with an obstacle.

In the preceding description, for purposes of explanation, numerous details are set forth in order to provide a thorough understanding of the embodiments. However, it will be apparent to one skilled in the art that these specific details may not be required. In other instances, well-known structures may not be described in detail in order not to obscure the understanding of the embodiments.

The above-described embodiments are intended to be examples only. Alterations, modifications and variations can be effected to the particular embodiments by those of skill in the art without departing from the scope herein.

What is claimed is:

1. A mounting assembly for mounting a tool to a frame, the mounting assembly comprising:
a base for attaching to the frame;
a bushing fastener connected to the tool; and
an elastomeric bushing between the base and the bushing fastener for allowing dampened movement of the tool with respect to the frame.

2. The mounting assembly of claim 1 further comprising:
a frame attachment for attaching the base to the frame; and
a pivot bolt provided in the frame attachment;
wherein the tool pivots about the pivot bolt to cause the bushing bolt to compress the elastomeric bushing.

3. The mounting assembly of claim 2, wherein the elastomeric bushing provides dampening of rotational movement of the tool.

4. The mounting assembly of claim 1 further comprising:
a tool attachment attached to the tool and having a groove; and
a shaft provided in the groove and connected to the bushing fastener.

5. The mounting assembly of claim 1, wherein the elastomeric bushing comprises natural rubber or a synthetic elastomer.

6. The mounting assembly of claim 1, wherein tightening or loosening the bushing fastener adjusts the dampened movement of the tool.

7. The mounting assembly of claim 1, wherein the elastomeric bushing is removable and replaceable by unfastening the bushing fastener.

8. The mounting assembly of claim 1, wherein the elastomeric bushing is selected to provide a desirable amount of dampened movement of the tool.

9. The mounting assembly of claim 1, wherein the tool is selected from any one of a cultivator implement, a shank, a C-shank, a S-tine, a tiller, an aerator, a shovel, a chisel plough, a hoe, a mattock, an opener, a knife, and a cultivator.

10. Agricultural equipment comprising:
a tool for working the land;
a frame for attaching to a drive system;
a base attached to the frame;
a bushing fastener connected to the tool; and
an elastomeric bushing between the base and the bushing fastener for allowing dampened movement of the tool with respect to the frame.

11. The agricultural equipment of claim 10 further comprising:
a frame attachment attaching the base to the frame; and
a pivot bolt provided in the frame attachment;
wherein the tool pivots about the pivot bolt to cause the bushing bolt to compress the elastomeric bushing.

12. The agricultural equipment of claim 11, wherein the elastomeric bushing provides dampening of rotational movement of the tool.

13. The agricultural equipment of claim 10 further comprising:
a tool attachment attached to the tool and having a groove; and
a shaft provided in the groove and connected to the bushing fastener.

14. The agricultural equipment of claim 10, wherein the elastomeric bushing comprises natural rubber or a synthetic elastomer.

15. The agricultural equipment of claim 10, wherein tightening or loosening the bushing fastener adjusts the dampened movement of the tool.

16. The agricultural equipment of claim 10, wherein the elastomeric bushing is removable and replaceable by unfastening the bushing fastener.

17. The agricultural equipment of claim 10, wherein the elastomeric bushing is selected to provide a desirable amount of dampened movement of the tool.

18. The agricultural equipment of claim 10, wherein the tool is selected from any one of a cultivator implement, a shank, a C-shank, a S-tine, a tiller, an aerator, a shovel, a chisel plough, a hoe, a mattock, an opener, a knife, and a cultivator.
